(19) United States
(12) Patent Application Publication
(10) Pub. No.: US 2008/0192489 A1
(43) Pub. Date: Aug. 14, 2008

(54) PUK LED light fixture

(75) Inventor: Patrick Ward, San Antonio, TX (US)

Correspondence Address: STRASBURGER & PRICE, LLP, 901 MAIN STREET, SUITE 4400, DALLAS, TX, 75202, US

(73) Assignee: Lucifer Lighting Co.

(21) Appl. No.: 12/069,609

(22) Filed: Feb. 12, 2008

Related U.S. Application Data
(60) Provisional application No. 60/900,879, filed on Feb. 12, 2007.

(51) Int. Cl. F21V 15/00

(52) U.S. Cl. 362/364

(57) ABSTRACT

The PUK LED light fixture of the present invention includes an LED light source including the necessary electrical componentry to enable the electrical energy applied thereto to cause light to be emitted from the one or more LEDs contained thereon. An LED light source retainer assembly positions the LED light source within the PUK LED light fixture. Underneath the LED light source is a light effects element for changing the characteristics of the light rays emitted from the one or more LEDs. A trim ring is positioned under the LED light source retainer assembly.

### CROSS REFERENCE TO RELATED APPLICATION

This application claims the benefit of Provisional U.S. Patent Application No. 60/900879 filed Feb. 12, 2007.

### STATEMENT REGARDING FEDERALLY FUNDED RESEARCH AND DEVELOPMENT

The invention described in this patent application was not the subject of federally sponsored research or development.

### FIELD

The present invention pertains to light fixtures, more particularly the present invention pertains to small light fixtures having low visibility to the observer when used in a product display, in a decorative application, in an interior space, in an exterior space or in a utilitarian application such as in an item of furniture.

### BACKGROUND

Interior designers often use light to provide decorative accents in commercial applications, unique effects within rooms in businesses or residences, unique effects in exterior spaces, or to illuminate spaces within furniture. In a store setting designers of interior commercial spaces use the light from small light fixtures to showcase particular products in either display cases or in floor displays. In an office setting or in a home setting, small lighting fixtures are used to create unique lighting effects which dramatize both room design and interior decoration. In an exterior setting small lighting fixtures may be used to illuminate outdoor living areas such as porches or patios. In furniture, small lighting fixtures are used to illuminate interior spaces within cabinets or to showcase displayed items such as collections of unique items. In all settings, architects, interior/exterior space designers and furniture craftsmen desire to enhance their work with light but, at the same time, architects, interior/exterior designers and furniture craftsmen seek to minimize the visibility of the small light fixture from which the light originates.

In response to the needs of architects, interior/exterior designers and furniture craftsmen for a source of light from a small light fixture, which small light fixture is effectively invisible to the viewer, the Lucifer Lighting Co., the owner of the instant patent application, developed a small light fixture which has come to be known in the industry as a PUK light. The name PUK light originated because of the similarity in size and shape of the small light fixture to a hockey puck. The light source used in prior art PUK lights has typically been a small incandescent bulb.

Some who have used the prior art PUK light in architectural applications, room design, outdoor space lighting design and in furniture have learned that the PUK light can be used in ceilings where only a small space is available above the ceiling, or the PUK light can be recessed into the bottom of a shelf, the sides, top or bottom of built-ins or a free standing piece of furniture. For example, a hole formed in a ¾ inch thick shelf can be used for the mounting of a PUK light. Others have chosen a surface mounting for the prior art PUK light rather than a recessed mounting.

While the prior art PUK light has become very popular among architects, interior/exterior designers and furniture craftsmen using light for either a decorative or utilitarian purpose, the prior art PUK light is not without its limitations. Because of the small size and confined spaces in which the PUK light is often mounted, heat dissipation can become a problem. An additional effect of the accumulation of heat has been a reduction in the life of the incandescent light bulb contained within a prior art PUK light. Further, the accumulation of heat may make an item such as a display case or an item of furniture, in which the PUK light is mounted, uncomfortable to the touch.

Because of the utility, versatility and dramatic lighting effects that have been achieved by use of Lucifer Lighting's prior art PUK light containing an incandescent light source, prior art PUK lights have found their way into an expanded range of applications. Specifically, prior art PUK lights have been considered for use in interior spaces in high end RVs, in custom built yachts, in outdoor applications near water, and in aircraft having custom designed interior spaces. This desire to use PUK lights in recreational vehicles, watercraft, outdoor applications near water and aircraft has presented a new set of challenges in PUK light design. For example, the vibration of a moving vehicle places stress on the delicate filaments used in the incandescent bulbs found in prior art PUK lights. Further, since size and weight are often considerations for recreational vehicles, watercraft, and aircraft, a need has arisen to find ways minimize both the size and weight of the PUK light fixture. In addition, to meet regulatory requirements and insurance requirements, some construction standards for recreational vehicles, watercraft, and aircraft require that all light fixtures be protected within a sealed environment.

Despite the small size of the existing prior art PUK light, some architects, interior/exterior designers and furniture craftsmen have asked for smaller PUK lights, with smaller trim ring openings, that will emit the same or greater amounts of light than prior art PUK lights.

Minimizing energy utilization has also become a major consideration among those desiring to use a PUK light. Accordingly, users of PUK lights are demanding smaller light fixtures which put out as much or more light as prior art PUK light fixtures and, at the same time, consume less electrical energy.

Accordingly, there is a need in the art for an improved small light fixture that can be made smaller, lighter, provide more illumination, and use less energy than prior art PUK lights.

### SUMMARY

The disclosed PUK LED light fixture of the present invention can be made smaller, lighter, provide more light and use less energy than prior art PUK lights.

According to the present invention, the disclosed PUK LED light fixture can be either surface mounted or recess mounted. Included within the disclosed PUK LED light fixture is an LED light source. The LED light source has one or more LEDs electrically connected to a set of electrical componentry positioned adjacent to the one or more LEDs. The electrical componentry enables the one or more LEDs to illuminate when electrical energy is applied thereto.

The LED light source is positioned and mounted within an LED light source retainer assembly.

Positioned beneath the LED light source is a lighting effects element. The lighting effects element modifies the characteristics of the light emitted from the LED light source.

Visible to the user is a trim ring assembly positioned under the LED light source retainer assembly. The trim ring assembly may include exposed fasteners or it may hide the fasteners that are used with a flange surrounding the light source retainer assembly.

### BRIEF DESCRIPTION OF THE DRAWING FIGURES

A still better understanding of the PUK LED light fixture of the present invention may be had by reference to the drawing figures wherein:

FIG. 1A is a perspective view of a substantially circular LED light source;

FIG. 1B is a perspective view of a substantially rectangular LED light source;

FIG. 2A is an exploded perspective view of a recess mounted PUK LED light fixture with exposed fasteners;

FIG. 2B is a perspective view of the assembled PUK LED light fixture shown in FIG. 2A;

FIG. 3A is an exploded perspective of a surface mounted PUK LED light fixture with exposed fasteners;

FIG. 3B is a perspective view of the assembled PUK LED light fixture shown in FIG. 3A;

FIG. 4A is an exploded perspective view of a recessed mounted PUK LED light fixture with hidden fasteners;

FIG. 4B is a perspective view of the recess mounted PUK LED light fixture shown in FIG. 4A in its assembled condition;

FIG. 5A is an exploded perspective view of a surface mounted PUK LED light fixture with hidden fasteners;

FIG. 5B is a perspective view of the surface mounted PUK LED light fixture shown in FIG. 5A in its assembled condition;

FIG. 6A is an exploded perspective view from above of a recessed mounted PUK LED light fixture with a substantially square trim ring and exposed fasteners;

FIG. 6B is an exploded perspective view from below of the recess mounted PUK LED light fixture shown in FIG. 6A;

FIG. 6C is a plan view looking up into an embodiment of the PUK LED light fixture shown in FIGS. 6A and 6B;

FIG. 7 is an exploded perspective view of a recessed mounted PUK LED light fixture for use in either wet locations or in locations requiring some type of light fixture protection; and

FIG. 8 is a schematic diagram of a plurality of PUK LED light fixtures for use with an AC dimming circuit.

### DESCRIPTION OF THE EMBODIMENTS

As previously indicated, the type of light fixture disclosed herein is called a PUK light because of its similarity to the shape of a hockey puck. While it is well known that the dimensions of a cylindrical hockey puck are about 3 inches in diameter and about 1 inch in thickness, for the purposes of the disclosure of the present invention disclosure the term “substantially the size of a hockey puck” shall be defined herein to included substantially cylindrical structure having a diameter from about 2 inches to about 6 inches and a thickness from about ⅜ inches to about 2 inches. Also included within the foregoing definition are substantially oval-shaped, substantially ellipsoidal-shaped structures, or structures formed substantially in the shape of a polygon with straight sides.

The disclosed PUK LED light fixture is substantially the size of a hockey puck, as defined above, and provides the following advantages to architects, interior room designers, exterior lighting space designers and furniture craftsmen:

reduced overall thermal load;

long light source life expectancy, even in high vibration environments, thus reducing maintenance costs to users by reducing the frequency of light source replacement;

adjustable/tunable light ray control;

light ray color control;

smaller and lighter housings than prior art PUK light fixtures;

smaller trim ring light openings than prior art PUK light fixtures;

ease of installation and service; and

reduced power utilization.

In the drawing figures, the same reference numbers have been used to designate similar parts. However, to distinguish between embodiments, the number used in the “hundreds” place changes as between the drawing figures.

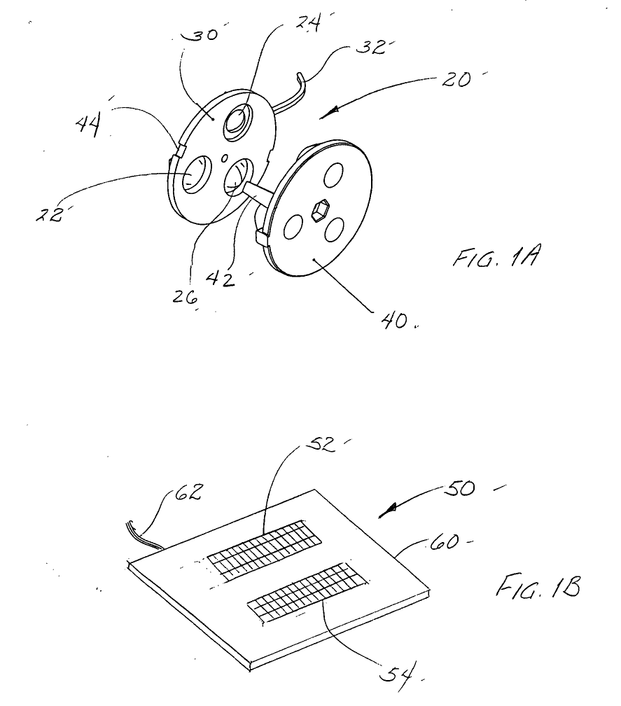

Shown in FIG. 1A is a substantially circular LED light source 20 The light rays are emitted from three substantially circular LED's 22, 24, 26 in the LED light source 20. Any number of LEDs may be used in the LED light source 20 depending on the size of the LEDs used. The individual LEDs 22, 24, 26 may all emit a single color of light or each individual LED may emit a different color of light.

The LEDs are mounted on or within a small circuit board 30. The small circuit board 30 includes a set of electrical componentry mounted thereon to use supplied electrical energy, either AC or DC, through lead 32 and the transform the characteristics of the supplied electrical energy into those characteristics which cause the one or more LEDs to illuminate. Such set of electrical componentry for use with LEDs is well known to those of ordinary skill in the art.

It is well known in the art that LEDs will emit light when low voltage DC electrical energy is applied. However, low voltage DC electrical energy is typically not available in either commercial or residential applications unless available AC electrical energy has been converted to low voltage DC electrical energy using an AC to DC transformer connected to the source of AC electrical energy. Alternatively, AC electrical energy having a variety of different voltages may be applied directly to the electrical componentry mounted on the small circuit board 30. The set of electrical componentry is selected to transform the applied AC electrical energy into rapidly pulsating DC electrical energy whose voltage will cause the LEDs mounted on the circuit board to emit light rays.

In actual operation, a 2.8 watt LED light source has provided satisfactory results; however, LED light sources of a variety of different wattages may be used. The LEDs light source 20 may include an optical lens element 40 positioned and spaced with respect to the array of LEDs 22, 24, 26 using, for an example a key 42 and slot 44. The optional optical lens element 40 may be used to spread, narrow or color the light emitted by LEDs 22, 24, 26.

Shown in FIG. 1B is a light source 50 with a linear array of LED panels 52, 54 positioned on a substantially rectangular circuit board 60 to which a power cord 62 is attached. Those of ordinary skill in the art will understand that substantially circular LEDs as shown in FIG. 1A may be used on substantially rectangular circuit board 60 and substantially linear LED panels 52, 54 may be used on a substantially circular circuit board 30. And, as previously indicated, a set of single color LEDs or a set of LEDs of multiple colors may be used.

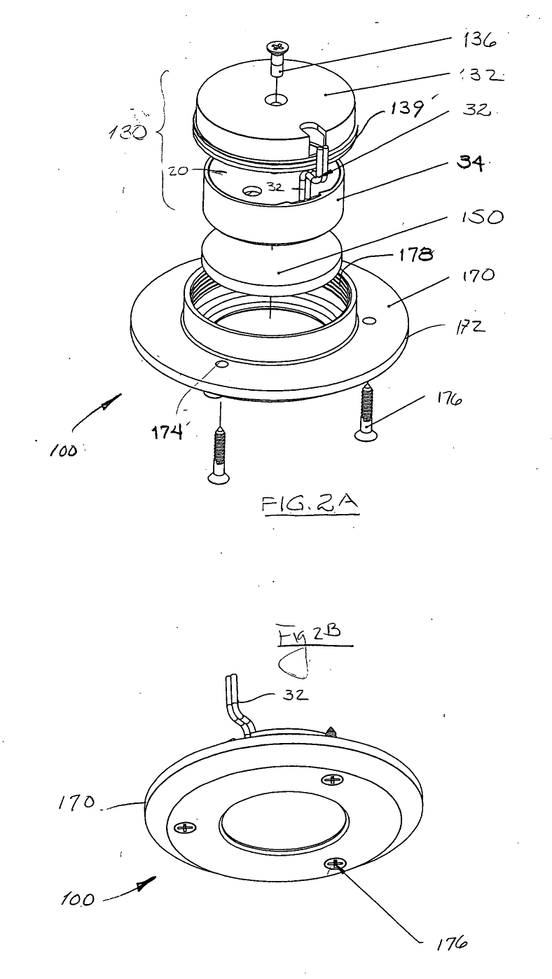

Shown in FIGS. 2A and 2B is a first embodiment of a PUK LED light fixture 100 for recessed mounting. Positioning and mounting the LED light source 20 is an LED light source retainer assembly 130. As shown in FIG. 2A the LED light source retainer assembly 130 includes a backing plate 132. The backing plate 132 positions and provides a mounting for an LED light source 20 which may come with or without an integral collar 34. A threaded fastener 136 may be used to attach the LED light source 20 to the backing plate 132.

Shown under the LED light source retainer assembly 130 is a light effects element 150. One or more different types of light effects elements 150 may be used. The one or more different types of light effects elements 150 are used to modify the characteristics of the light energy emitted by the one or more LEDs in the light source assembly 20. Those of ordinary skill in the art will understand that the one or more different types of light effects elements 150 may be used to shape or alter the pattern of emitted light rays from the one or more LEDs such as from a wide or flood array to a narrow or spot array. If desired the one or more different types of light effects elements 150 may be one or more filters to reduce either the intensity or the glare from the one or more LEDs. Such one or more filters may also include one or more color pigments for altering the color of the emitted light. In addition baffles, grids or louvers may be used as a light effects element 150.

Underneath the light effects element 150 is located a trim ring assembly 170. In the embodiment illustrated in FIGS. 2A and 2B, the light effects element 150 rests within the trim ring assembly 170 and provides support for the LED light source retainer assembly 130. Surrounding the trim ring assembly 170 is a substantially circular flange 172 with holes 174 formed therein. Passing through the holes 174 are a plurality of fasteners 176. Included in the preferred embodiment are internal threads 178 within the trim ring assembly which mate with external threads 139 on the backing plate 132. Those of ordinary skill in the art will understand that other attachment methods such as clip, cams, or spring loaded detents may be used to attach the backing plate 132 to the trim ring assembly 170.

The PUK LED light fixture 100 as illustrated in FIGS. 2A and 2B is inserted into a hole formed in a ceiling panel or in the underside of a shelf, for example. The LED light source retainer assembly 130 is positioned with the hole in the ceiling panel or shelf and the fasteners 176 passing through the holes 174 substantially circular flange portion 172 of the trim ring assembly 170 engage the flat surface surrounding the hole or space which enables the recessed mounting of the PUK LED light fixture 100.

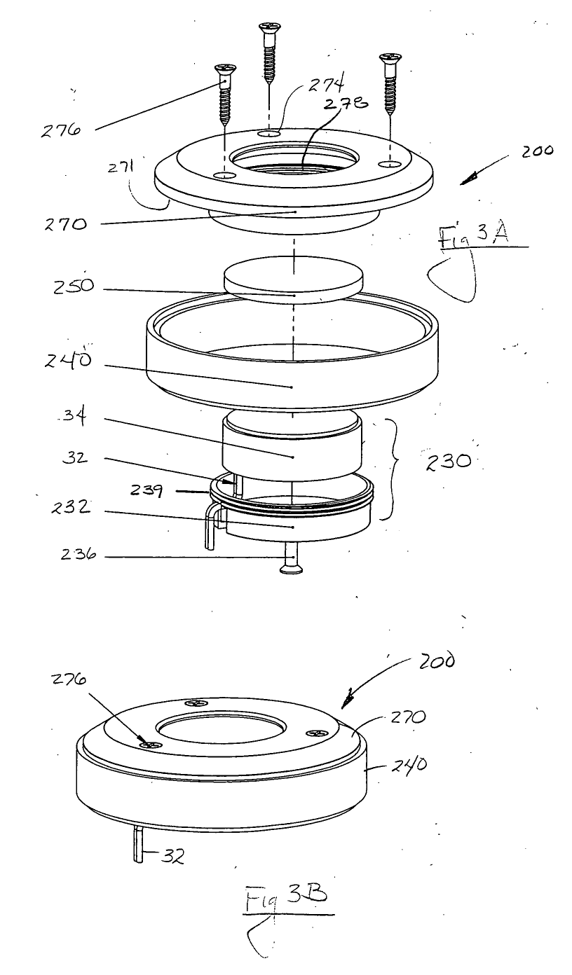

As may be seen in the embodiment 200 illustrated in FIGS. 3A and 3B, a hole or space is not always available for the mounting of the PUK LED light fixture of the present invention. Accordingly, the PUK LED light fixture of the present invention may be constructed to be a surface mount fixture. As shown in the embodiment 100 illustrated in FIGS. 2A and 2B, the LED light source 20 used in the embodiment shown in FIGS. 3A and 3B is mounted on a backing plate 232 which is part of the LED light source retainer assembly 230. Underneath the LED light source retainer assembly 230 are the one or more different types of the light effects element 250. Surrounding the LED light source retainer assembly 230 is an extension ring 240. The extension ring 240 serves as a spacer between the underside 271 of the trim ring assembly 270 and the flat surface against which the PUK LED light fixture 200 is mounted. As in the embodiment shown in FIGS. 2A and 2B the fasteners 276 for attaching the PUK LED light fixture 200 to the flat surface are exposed for easy access. Those of ordinary skill in the art will understand that the extension ring 240 and the trim ring assembly 270 may be formed as a single unit.

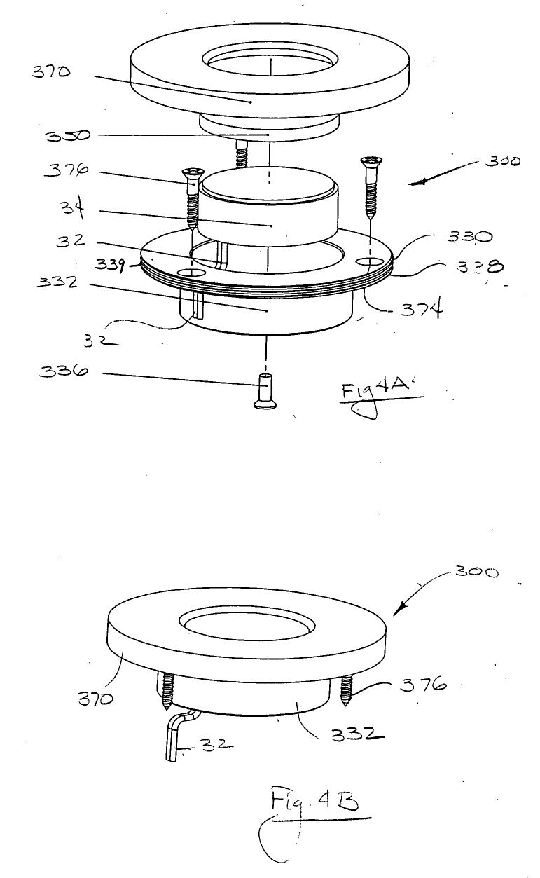

In some situations it may be objectionable for the exposed fasteners to be visible. The PUK LED light fixture 300 for use in a recessed application is shown in FIGS. 4A and 4B. Instead of the trim ring assembly being mounted to the flat surface, the upper portion of the LED light source retainer assembly 330 includes a flange 338. Fasteners 376 pass through holes 374 in the flange 338 to engage the flat surface surrounding the hole or space onto which the PUK LED light fixture 300 fits. The trim ring assembly 370 is then threadable 339 attached thereto and the tops of the fasteners 376 are hidden as shown in FIG. 4B.

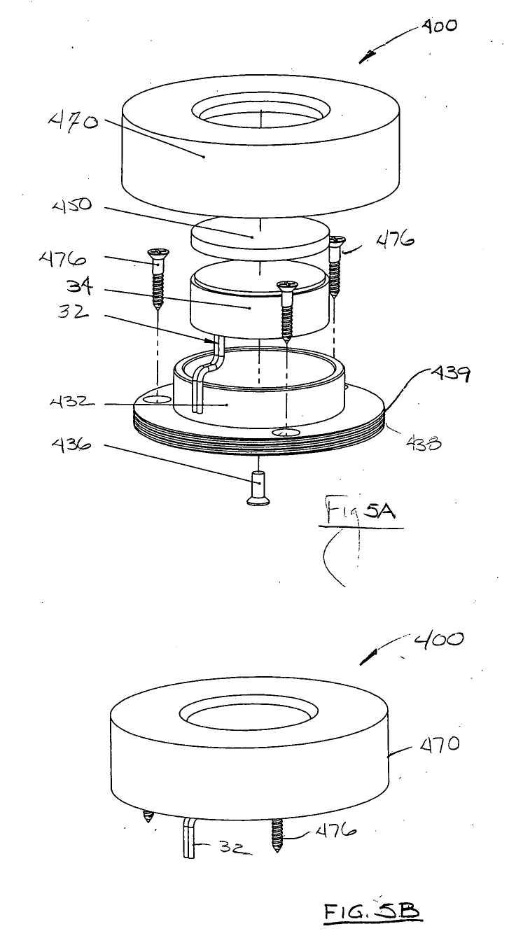

Shown in FIGS. 5A and 5B is a surface mounted PUK LED light fixture 400 where the tops of the fasteners 476 are hidden from view. As in the embodiment 300 shown in FIGS. 4A and 4B, a flange 438 surrounds the top portion of the LED light source retainer assembly 430. The fasteners 476 pass through holes 474 in the flange 432 on the top portion of the LED light source retainer assembly 430 and engage the flat surface on which the PUK LED light fixture 400 is mounted. Herein the thickness of the trim ring assembly 470 provides the same function as the extension ring 240 shown in FIG. 3A. The trim ring assembly 470 threadably 439 engages the LED light source retainer assembly 430 as shown in FIG. 5B.

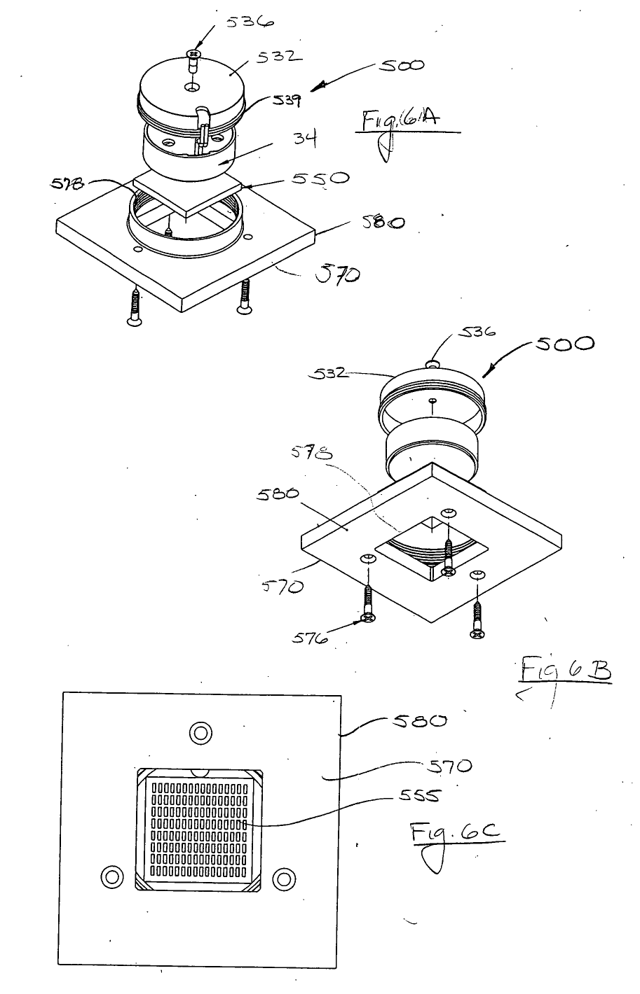

Some architects, interior/exterior designers, and furniture craftsmen prefer to use a substantially square or a substantially rectangular shaped light fixture. The embodiment of the PUK LED light fixture 500 shown in FIGS. 6A, 6B and 6C meets this need. Instead of the substantially circular shape of the LED light source 20 shown FIGS. 6A and 6B and described with respect to the previous embodiments, the LED light source 50 used in the embodiment shown in FIGS. 6A, 6B and 6C may be the substantially rectilinear LED light 50 illustrated in FIG. 1B. The substantially linear array of LEDs 52, 54 in LED light source 50 emits a pattern of light rays that may be better suited to passage through a substantially square or substantially rectilinear opening 578 in a trim ring assembly 570. Accordingly, the trim ring assembly 570 includes a substantially square or a substantially rectilinear opening 578 surrounded by a substantially square or a substantially rectilinear trim ring assembly 580. While the embodiment shown is for a recessed application with exposed fasteners 576, those of ordinary skill in the art will be understood that the embodiment 500 illustrated may be manufactured such that fasteners 576 are hidden as shown in FIGS. 5A and 5B. Alternatively, the embodiment shown in FIGS. 6A and 6B may be made for surface mounting and made include either exposed or hidden fasteners. Further, those of ordinary skill in the art will understand that numerous different arrays of LEDs may be used including accurate shapes, linear shapes or a combination thereof. Shown in FIG. 6C is an optional expanded metal screen or grid 555 that may be used to modify the lighting effect.

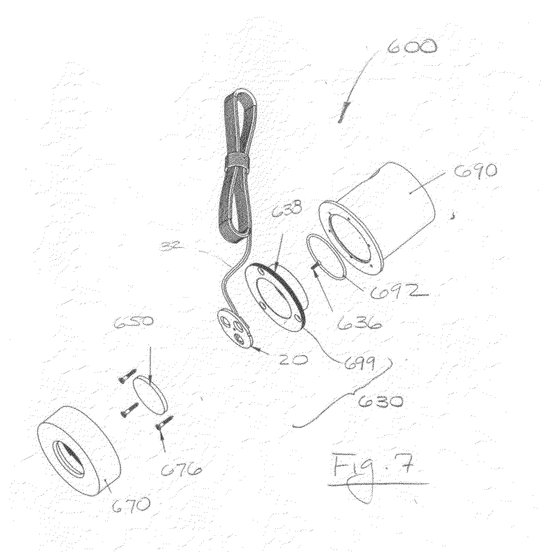

As previously indicated the popularity of the prior art PUK light has expanded its use into outdoor, exterior and marine locations where moisture can be a problem. In such cases there is a need to protect the PUK LED fixture of the present invention from the corrosive effects of moisture by using a protective housing as shown in FIG. 7. Shown in FIG. 7 is a PUK LED fixture 600 similar to that shown in FIG. 5A and FIG. 5B. Placed over the top of the fixture is a protective housing 690. Beneath the protective housing is an o-ring 692 which sealingly engages a flange 638 extending outwardly from the top portion of the LED light source retainer assembly 630. By use of the protective housing 690 which sealingly engages the LED light source retainer assembly 630 of the PUK LED light assembly 600, the disclosed PUK LED light fixture 600 may be used in environments characterized by high moisture levels or where construction requirements necessitate such protection.

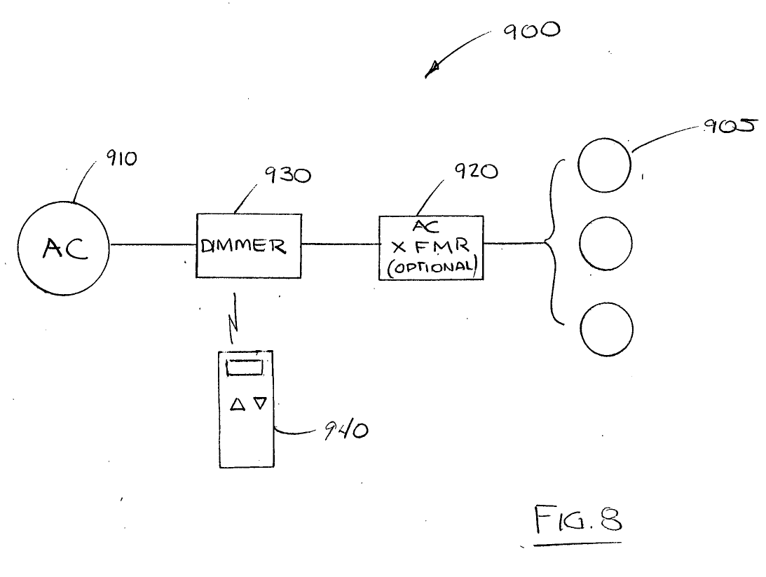

Shown in FIG. 8 is a schematic illustrating a lighting system 900 including a set of one or more PUK LED light fixtures 905 connected to an AC power supply 910. As previously indicated an AC power supply such a 20 VAC 910 with a output may be used or the AC voltage may be the voltage of the electrical energy received from the AC power supply reduced by an optional AC transformer 920 to a level such as about 12 VAC as often found in dimmable AC powered lighting installations.

As shown in FIG. 8 the electrical energy from the AC power supply may pass through a commonly available dimmer 930. A control signal to the dimmer 930 may be provided by a hand-held remote control 940 or alternatively by a slidable or rotating wall control. One of the advantages of the illustrated system 900 is that a commonly available dimmer 930 may be used and a uniform dimming of the light emitted from the set of PUK LED lighting fixtures 905 from full bright to completely off is enabled without the need for special equipment.

While the disclosed PUK LED light fixtures have all been made from aluminum, other materials such as a conductive polymer may be used in place of aluminum without detracting from the operation of the PUK LED light fixture.

While the PUK LED light fixture has been disclosed according to its preferred and alternate embodiments, those of ordinary skill in the art will understand that numerous other embodiments have been enabled by the foregoing disclosure. Such other embodiments shall be included within the scope and meaning of the appended claims.

I claim:

1. A recessed lighting fixture substantially the size of a hockey puck, said recessed lighting fixture being mountable within a hole or space connecting with a flat surface, said recessed lighting fixture comprising:
an LED light source including at least one LED mounted on a circuit board having the necessary electrical componentry to enable said at least one LED to illuminate with the application of electrical energy thereto;
an LED light source retainer assembly constructed and arranged for positioning and mounting said LED light source within the recessed lighting fixture;
a lighting effects element constructed and arranged for positioning under said LED light source retainer assembly for modifying the characteristics of the light rays emitted from said LED light source;
a trim ring assembly for positioning and mounting said light effects elements, said light source retainer assembly, and said LED light source one with respect to another, said trim ring assembly being mountable to the flat surface.

2. The recessed lighting fixture as defined in claim 1 wherein said LED light source assembly is powered by AC electrical energy

3. The recessed lighting fixture as defined in claim 1 wherein said LED light source assembly is powered by DC electrical energy.

4. The recessed lighting fixture as defined in claim 1 wherein said LED light source assembly includes an optical lens element.

5. The recessed lighting fixture as defined in claim 1 wherein said lighting effects element is selected from a group including one or more of a lens, a filter, a colored filter, a baffle, a grid, or louvers.

6. The recessed lighting fixture as defined in claim 1 wherein said LED light source includes a linear array of LEDs and said trim ring assembly is formed in a substantially rectilinear shape.

7. A surface mount light fixture substantially the size of a hockey puck, said surface mount light fixture being mountable to a substantially flat surface, said surface mount light fixture comprising:
an LED light source containing at least one LED positioned on a circuit board including the necessary electrical componentry to provide electrical energy to said at least one LED so that said at least one LED will illuminate;
an LED light source retainer assembly constructed and arranged for the positioning and mounting of said LED source within the lighting fixture;
at least one lighting effects element constructed and arranged for positioning under said LED light source retainer assembly for modifying the light rays emitted by said LED light source;
a trim ring assembly constructed and arranged for positioning said light effects element, said LED light source retainer assembly and said LED light source one with respect to another, said trim ring assembly being mountable to the flat surface;
an extension ring positionable between said trim ring assembly and the flat surface.

8. The surface mount light fixture as defined in claim 7 wherein said LED light source is powered by AC electrical energy.

9. The surface mount light fixture as defined in claim 7 wherein said LED light source is powered by DC electrical energy.

10. The surface mount light fixture as defined in claim 7 wherein said LED light source includes an optical lens element.

11. The surface mount light fixture as defined in claim 7 wherein said one or more lighting effects element is selected from a group including a lens, a filter, a colored filter, a baffle, a grid, or louvers.

12. The surface mount light fixture as defined in claim 7 wherein said LED light source includes a linear array of LEDs and said trim ring assembly is formed in a substantially rectilinear shape.

13. A recessed lighting fixture, said recessed lighting fixture being mountable within a hole connecting to a flat surface, said recessed lighting fixture further comprising:
an LED light source including one or more LEDs and sufficient electrical componentry for applying electrical energy to said one or more LEDs to cause said one or more LEDs to illuminate;
an LED light source retainer assembly substantially the size of a hockey puck constructed and arranged for both positioning and mounting said LED light source within the recessed lighting fixture;
one or more lighting effects elements constructed and arranged for positioning under said LED light source for modifying the light rays emitted by said LED light source;
a trim ring assembly constructed and arranged for positioning and mounting said lighting effects element, said LED light source retainer assembly, and said LED light source one with respect to another.

14. The recessed lighting fixture as defined in claim 13 wherein said trim ring assembly is mountable to the flat surface.

15. The recessed lighting fixture as defined in claim 13 wherein said LED light source retainer assembly is mountable to the flat surface.

16. The recessed lighting fixture as defined in claim 13 wherein said LED light source assembly is powered by AC electrical energy.

17. The recessed lighting fixture as defined in claim 13 wherein said LED light source assembly is powered by DC electrical energy.

18. The recessed lighting fixture as defined in claim 13 wherein said LED light source includes an optical lens element.

19. The recessed lighting fixture as defined in claim 13 wherein said lighting effects element is selected from a group including one or more of a lens, a filter, a colored filter, a baffle, a grid, or louvers.

20. The recessed lighting fixture as defined in claim 13 wherein said LED light source includes a linear array of LEDs and said trim ring assembly is formed in a substantially rectilinear shape.

21. A light fixture for mounting to a flat surface, said light fixture comprising:
an LED light source including at least one LED electrically connected to a power source for providing sufficient electrical energy to illuminate said at least one LED;
an LED light source retainer assembly constructed and arranged for the positioning and mounting of said LED light source within the light fixture, said LED light source retainer assembly being substantially the size of a hockey puck;
one or more lighting effects elements positioned under said LED light source for modifying the light emitted by said at least one LED;
a trim ring assembly constructed and arranged for positioning said lighting effects element, said LED light source retainer assembly and said LED light source one with respect to another;
an extension ring constructed and arranged to be positionable between said trim ring assembly and the flat surface.

22. The light fixture as defined in claim 21 wherein said trim ring assembly is mountable to the flat surface.

23. The light fixture as defined in claim 21 wherein said LED light source retainer assembly is mountable to the flat surface.

24. The light fixture as defined in claim 21 wherein said LED light source is powered by AC electrical energy.

25. The light fixture as defined in claim 21 wherein said LED light source is powered by DC electrical energy.

26. The light fixture as defined in claim 21 wherein LED light source includes an optical lens element.

27. The light fixture as defined in claim 21 wherein said lighting effects element is selected from a group including one or more of a lens, a filter, a colored filter, a baffle, a grid, or louvers.

28. The light fixture as defined in claim 21 wherein said LED light source includes a linear array of LEDs and said trim ring assembly is formed in a substantially rectilinear shape.

29. A substantially hockey puck sized light fixture for mounting to a flat surface, said substantially hockey puck sized light fixture comprising:
an LED light source including one or more LEDs and the electrical componentry needed to transform the characteristics of available electrical energy to those characteristics needed to cause said one or more LEDs to illuminate;
an LED light source retainer assembly constructed and arranged for both positioning and mounting said LED light source within the hockey puck sized light fixture;
one or more lighting effect elements positioned under said LED light source;
a trim ring positioned under said lighting effects element;
a housing sealingly connected over said LED light source retainer assembly.

30. An AC powered lighting system comprising:
a set of lighting fixtures wherein each lighting fixture is substantially the size of a hockey puck, each of said lighting fixtures including:
an LED light source having one or more LEDs and the electrical componentry needed to cause said one or more LEDs to illuminate when AC electrical energy is applied thereto;
an LED light source retainer assembly for positioning and maintaining said LED light source with each light fixture;
one or more lighting effects elements positioned under said LED light source;
a trim ring assembly positioned under said light effects element;
wherein said AC power source is electrically connected to said set of lighting fixtures

31. The AC powered lighting system as defined in claim 30 wherein a dimmer assembly is interposed between said AC power source and said set of lighting fixtures.

32. The AC powered lighting system as defined in claim 30 further including an AC voltage transformer.
